(19) United States
(12) Patent Application Publication
(10) Pub. No.: US 2010/0141568 A1
(43) Pub. Date: Jun. 10, 2010

(54) LIQUID CRYSTAL DISPLAY

(76) Inventors: Sang-Jin Lee, Suwon-si (KR); Yun-Hee Kim, Suwon-si (KR); Su-Kyung Lee, Suwon-si (KR); Jong-Woon Moon, Suwon-si (KR); Jong-Hwan Park, Suwon-si (KR); Hun-Soo Kim, Suwon-si (KR)

Correspondence Address: CHRISTIE, PARKER & HALE, LLP, PO BOX 7068, PASADENA, CA, 91109-7068, US

(21) Appl. No.: 12/630,805

(22) Filed: Dec. 3, 2009

(30) Foreign Application Priority Data
Dec. 5, 2008 (KR) 10-2008-0123507

(51) Int. Cl. G09G 3/36

(52) U.S. Cl. 345/88; 345/102

(57) ABSTRACT

A liquid crystal display includes a liquid crystal panel having a color filter including a red filter, a transparent filter, and a blue filter, and a backlight panel at a rear of the liquid crystal panel. The backlight panel includes electron emission regions and a phosphor layer that emits light when excited by electrons emitted from the electron emission regions. The phosphor layer includes a first phosphor layer having a red phosphor and a blue phosphor, and a second phosphor layer having a green phosphor. The backlight panel is configured to emit light from the first phosphor layer and the second phosphor layer sequentially.

### CROSS-REFERENCE TO RELATED APPLICATION

This application claims priority to and the benefit of Korean Patent Application No. 10-2008-0123507 filed in the Korean Intellectual Property Office on Dec. 5, 2008, the entire content of which is incorporated herein by reference.

### BACKGROUND OF THE INVENTION

1. Field of the Invention

The present invention relates to a liquid crystal display (LCD). More particularly, the present invention relates to a liquid crystal display having a color filter.

2. Description of the Related Art

In general, an LCD includes a liquid crystal panel and a backlight panel that is disposed at a rear of the liquid crystal panel to provide white light to the liquid crystal panel. The liquid crystal panel changes light transmission of each sub-pixel by using dielectric anisotropy of liquid crystals in which a twist angle changes in accordance with an applied voltage, and changes white light into red light, green light, and blue light for each sub-pixel through a color filter, thereby realizing a color image.

A backlight panel with a cold cathode fluorescent lamp (CCFL) system is widely used. The CCFL is a line light source (i.e., light source having a line shape). Therefore, the backlight of the CCFL system includes optical members such as a light guide plate, a reflector plate, a diffuser sheet, and a prism sheet for uniformly dispersing and providing the light emitted from the CCFL to the liquid crystal panel.

However, according to the above described backlight panel of the CCFL system, a substantial amount of the light emitted from the CCFL is lost while passing through the optical members. In order to compensate for the light loss, a light of powerful intensity should be emitted from the CCFL. As a result, the backlight panel of the CCFL system has a drawback that power consumption is large. In addition, since it is difficult to significantly increase the surface area of the backlight panel of the CCFL system, it is hard to apply it to a large LCD.

Therefore, a field emission backlight panel has been recently proposed, which includes a cold cathode electron source and a phosphor layer inside a vacuum panel. The field emission backlight panel emits electrons from the cold cathode electron source by using an electric field, excites a phosphor layer with these electrons, and emits visible light. This field emission backlight panel has high luminance and low power consumption, and its surface area can easily be increased to be large in size.

In a field emission backlight panel, the phosphor layer is made up of a mixed phosphor in which a green phosphor (G), a blue phosphor (B), and a red phosphor (R) are mixed to emit white light when the phosphors are excited. Luminous efficiency of the field emission backlight panel is determined by a mixture ratio of the green phosphor (G), the blue phosphor (B), and the red phosphor (R), and this mixture ratio is determined by color temperature. One sheet of light diffusing member can be located between the backlight panel and the liquid crystal panel.

In this condition, the color temperature required for the liquid crystal panel is approximately 10,000K, and the color temperature required for the backlight panel is approximately 50,000K. That is, since a portion of the white light emitted from the backlight panel is lost while passing through a light diffusing member, a polarizer provided in the liquid crystal panel, a thin film transistor, a liquid crystal layer, and a color filter, the backlight panel should have a color temperature of approximately 50,000K in order for the liquid crystal panel to realize the color temperature of approximately 10,000K.

In a conventional field emission backlight panel, the mixture ratio of the green phosphor (G), the blue phosphor (B), and the red phosphor (R) is approximately 4:1:2, and the color temperature is less than 50,000K. Accordingly, in order to achieve the color temperature of 50,000K, the mixture ratio of the green phosphor (G), the blue phosphor (B), and the red phosphor (R) should be changed to approximately 1:2:1, and efficiency of the blue phosphor (B) and the red phosphor (R) should be improved.

However, there is much difficulty in further improving the efficiency of cathode luminescence (CL) phosphors of which the efficiency has been improved for the cathode ray tube and the field emission display over the past several years.

The above information disclosed in this Background section is only for enhancing the understanding of the background of the present invention, and therefore it may contain information that does not form the prior art that is already known in this country to a person of ordinary skill in the art.

### SUMMARY OF THE INVENTION

Embodiments of the present invention provide an LCD that can easily realize color temperature required for a liquid crystal panel by configuring a structure of a phosphor layer provided in the LCD as described in the exemplary embodiments.

An exemplary embodiment of the present invention provides an LCD including a liquid crystal panel having a color filter including a red filter, a transparent filter, and a blue filter, and a backlight panel that is located at a rear of the liquid crystal panel. The backlight panel includes electron emission regions and a phosphor layer that is excited by electrons emitted from the electron emission regions to emit visible light. The phosphor layer includes a first phosphor layer including a red phosphor and a blue phosphor, and a second phosphor layer including a green phosphor. The backlight panel is configured to emit light from the first phosphor layer and the second phosphor layer sequentially.

At least one of the first phosphor layer and the second phosphor layer may correspond to each pixel included in the backlight panel. The number of pixels in the backlight panel may be less than that in the liquid crystal panel.

The backlight panel may include a first substrate on which the plurality of electron emission regions are located, cathodes electrodes and gate electrodes disposed on a surface of the first substrate with an insulation layer formed therebetween, the cathodes electrodes crossing the gate electrodes at a substantially right angle, a second substrate facing the first substrate, wherein the phosphor layer is located on the second substrate. An anode electrode is provided on a surface of the second substrate.

A crossing region of the cathode electrodes and the gate electrodes may correspond to one pixel among a plurality of pixels included in the backlight panel, and at least one of the first phosphor layer and the second phosphor layer may correspond to each of the pixels of the backlight panel. The first phosphor layer and the second phosphor layer may extend in parallel with each other along a width direction of the gate electrodes. Each of the cathode electrodes may include a first sub-electrode corresponding to the first phosphor layer and a second sub-electrode corresponding to the second phosphor layer, and the first sub-electrode and the second sub-electrode may be separated from each other.

An on-time period of each of the plurality of pixels in the backlight panel may be divided into a first period and a second period. The first phosphor layer may emit light during the first period, and the second phosphor layer may emit light during the second period. The backlight panel may be configured to apply a driving voltage to the first sub-electrode during the first period, and apply a driving voltage to the second sub-electrode during the second period.

The liquid crystal panel may include first pixels, the backlight panel may include a number of second pixels that is less than that of the first pixels, and the second pixels may independently emit light in response to gray levels of the first pixels corresponding thereto.

### BRIEF DESCRIPTION OF THE DRAWINGS

FIG. 1 is an exploded perspective view of an LCD according to an exemplary embodiment of the present invention.

FIG. 2 is a partial cross-sectional view of a liquid crystal panel included in the LCD of FIG. 1.

FIG. 3 is a schematic diagram for illustrating a phosphor layer, which is a pixel area, of a backlight panel included in the LCD of FIG. 1.

FIG. 4 is a schematic diagram for illustrating the relationship between transmission of red light, green light, and blue light of the backlight panel to a color filter according to an embodiment of the present invention.

FIG. 5 is a partial exploded perspective view of the backlight panel included in the LCD of FIG. 1.

FIG. 6 is a partial cross-sectional view of the backlight panel illustrated in FIG. 5.

FIG. 7 and FIG. 8 are partial cross-sectional views for explaining an operation of the backlight panel illustrated in FIG. 5.

### DETAILED DESCRIPTION OF EXEMPLARY EMBODIMENTS

Hereinafter, the present invention will be described more fully with reference to the accompanying drawings, in which exemplary embodiments of the present invention are shown. As those skilled in the art would realize, the described embodiments may be modified in various different ways, all without departing from the spirit or scope of the present invention.

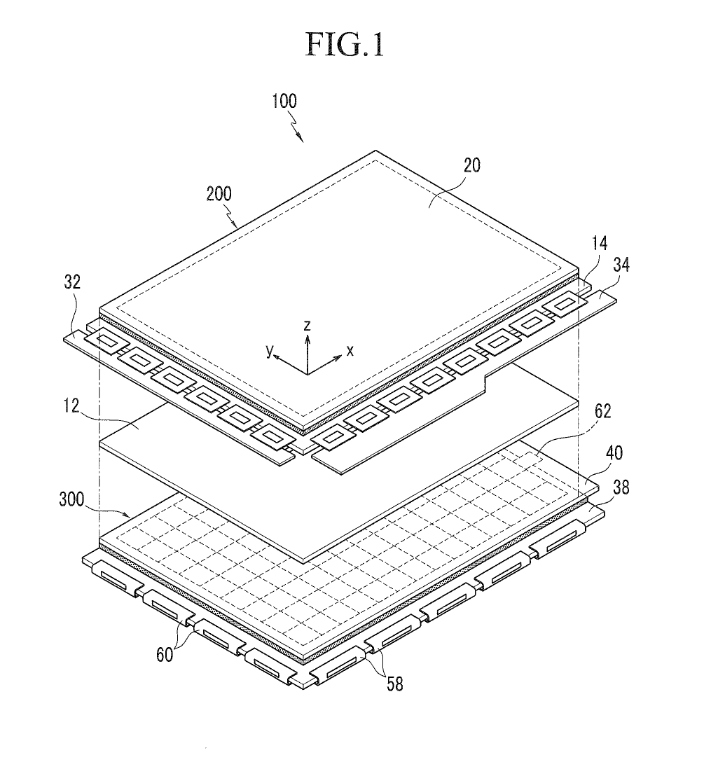

FIG. 1 is an exploded perspective view of an LCD according to an exemplary embodiment of the present invention.

Referring to FIG. 1, the LCD 100 of the present exemplary embodiment includes a liquid crystal panel 200 and a backlight panel 300 located at a rear of the liquid crystal panel 200 to provide white light to the liquid crystal panel 200. A light diffusing member 12 can be located between the liquid crystal panel 200 and the backlight panel 300 to uniformly diffuse light emitted from the backlight panel 300.

The backlight panel 300 of a field emission type includes electron emission regions formed of cold cathode electron emission materials, driving electrodes for controlling the amount of electrons emitted from the electron emission regions, and a phosphor layer that is excited by electrons to emit visible light. This backlight panel 300 has a plurality of pixels for independently controlling the amount of electron emission for each of the pixels by a combination of the driving electrodes.

The backlight panel 300 has a number of pixels that is less than that of the liquid crystal panel 200. Thus, one pixel of the backlight panel 300 corresponds to two or more pixels of the liquid crystal panel 200. Each pixel of the backlight panel 300 can emit light corresponding to the highest gray level among gray levels of a plurality of pixels of the liquid crystal panel 200 corresponding thereto. Furthermore, each pixel of the backlight panel 300 can represent, for example, a 2 to 8-bit grayscale.

Therefore, the backlight panel 300 can provide light of high luminance to a bright region in a screen embodied by the liquid crystal panel 200 and provide light of low luminance to a dark region in the screen. As a result, the LCD 100 as described above has improved contrast ratio and can realize clear image quality.

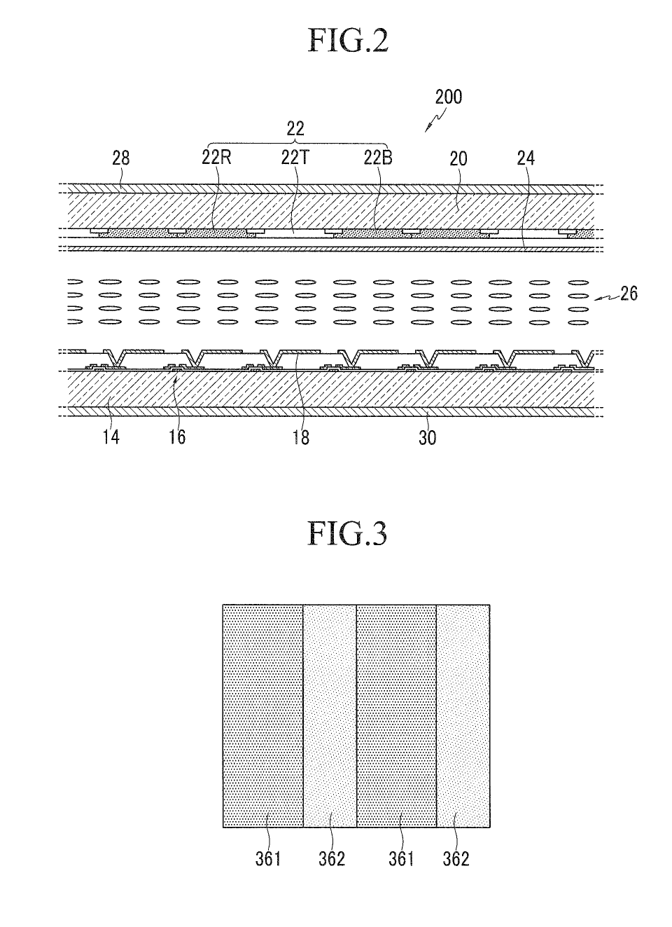

FIG. 2 is a partial cross-sectional view of a liquid crystal panel illustrated in FIG. 1.

Referring to FIG. 2, the liquid crystal panel 200 includes a plurality of TFTs 16 and a plurality of pixel electrodes 18 formed on an inside surface of a lower substrate 14, a color filter 22 and a common electrode 24 formed on an inside surface of an upper substrate 20, and a liquid crystal layer 26 injected between the upper substrate 20 and the lower substrate 14. Polarizers 28 and 30 are attached to the top of the upper substrate 20 and the bottom of the lower substrate 14, respectively, to polarize the light passing through the liquid crystal panel 200.

Each of the TFTs 16 and each of the pixel electrodes 18 are located in a corresponding sub-pixel, and the color filter 22 is made up of a red filter 22R, a transparent filter 22T, and a blue filter 22B, of which a corresponding one is provided in each sub-pixel.

An electric field is formed between the pixel electrode 18 and the common electrode 24 when the TFT 16 of a sub-pixel is turned on. Due to this electric field, an arrangement angle of liquid crystal molecules of the liquid crystal layer 26 is changed. Since optical transmittance is changed according to the changed arrangement angle, the liquid crystal panel 200 can control the luminance and color of light emitted from each pixel through these processes.

Referring to FIG. 1, a gate printed circuit board assembly (PBA) 32 for transmitting a gate driving signal to a gate electrode of each TFT 16 is illustrated, and a data printed circuit board assembly (PBA) 34 for transmitting a data driving signal to a source electrode of each TFT 16 is illustrated.

In the LCD 100 of the present exemplary embodiment, the liquid crystal panel 200 includes a color filter 22 composed of the red filter 22R, the transparent filter 22T, and the blue filter 22B. Moreover, the backlight panel 300 includes a first phosphor layer having a red phosphor and a blue phosphor and a second phosphor layer having a green phosphor with respect to each pixel.

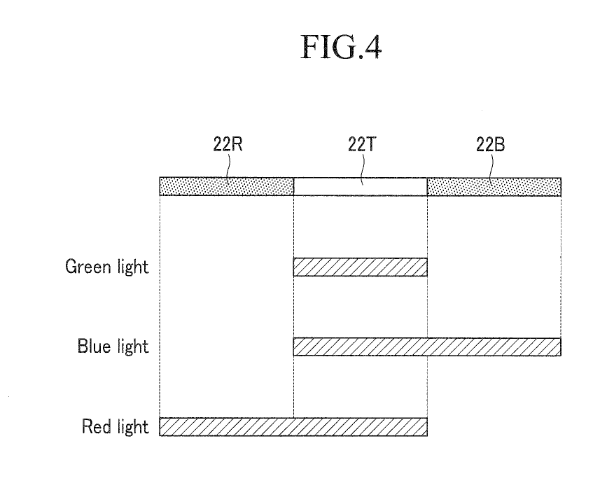

FIG. 3 is a schematic diagram illustrating a phosphor layer, which is a pixel area, of a backlight panel.

Referring to FIG. 3, the first phosphor layer 361 and the second phosphor layer 362 are located in one pixel of the backlight panel 300 side by side. The first phosphor layer 361 emits a light mixture of red light emitted from the red phosphor and blue light emitted from the blue phosphor, and the second phosphor layer 362 includes the green phosphor and emits green light. One or more first phosphor layers 361 and one or more second phosphor layers 362 can be provided in each pixel of the backlight panel 300. As an example, FIG. 3 illustrates an embodiment where two first phosphor layers 361 and two second phosphor layers 362 are alternately located.

According to a driving mode of the backlight panel 300 during a first period and a second period, the first phosphor layers 361 emit light during the first period, and the second phosphor layers 362 emit light during the second period. That is, one pixel of the backlight panel 300 can realize white light by sequentially emitting light from the first phosphor layers 361 and the second phosphor layers 362.

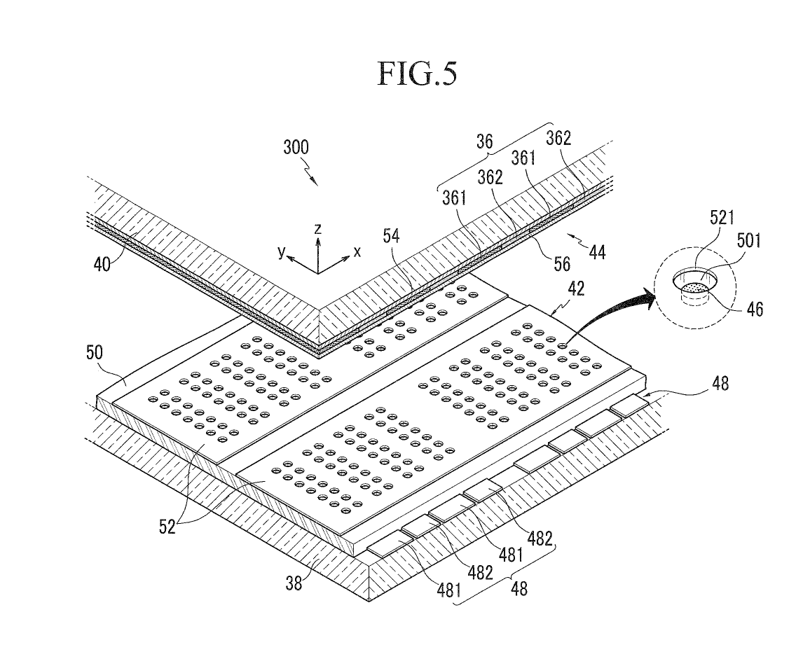

FIG. 4 is a schematic diagram illustrating the relationship of light transmission of the backlight panel to a color filter of the liquid display panel.

Referring to FIG. 4, when white light is emitted from one pixel of the backlight panel 300, the green component of the white light passes through only the transparent filter 22T, the blue component passes through the transparent filter 22T and the blue filter 22B, and the red component passes through the red filter 22R and the transparent filter 22T. That is, the transmittance of the blue light and the red light is two times as much compared to that of the conventional LCD because the blue component of the white light passes through only the blue filter, and the red component passes through only the red filter when the white light is emitted from the backlight panel 300.

Accordingly, the LCD 100 of the described exemplary embodiment has increased luminous efficiency of the red phosphor and the blue phosphor among the red phosphor, the green phosphor, and the blue phosphor making up the phosphor layer of the backlight panel 300, thereby easily realizing a color temperature required for the liquid crystal panel 200.

According to the described exemplary embodiment, the mixture ratio of the blue phosphor and red phosphor of the first phosphor layer 361 may be 2:1, and the mixture ratio of the blue phosphor, the green phosphor, and the red phosphor of the first phosphor layer 361 and the second phosphor layer 362 may be 2:2:1. The above described mixture ratios provide an appropriate color temperature (for example, 50,000K) required for the backlight panel 300.

Moreover, the first phosphor layer 361 and the second phosphor layer 362 of the described exemplary embodiment may have an area ratio of 3:2. Since the area ratio can be changed according to the efficiency of the phosphor forming the phosphor layer, the area ratio is not limited to the above-described value.

An inner configuration of the backlight panel 300 and an operation for sequentially emitting light from the first phosphor layer 361 and the second phosphor layer 362 will now be described.

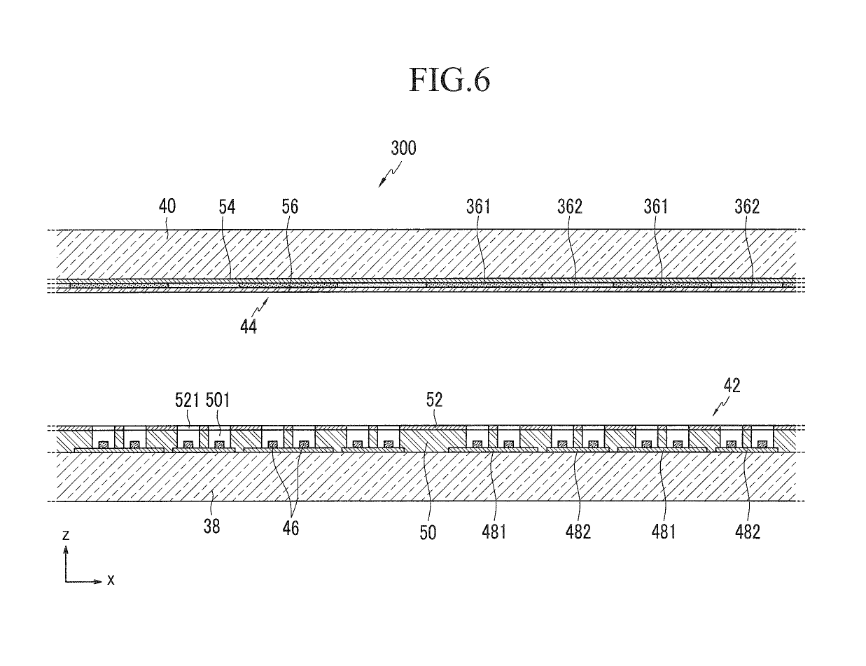

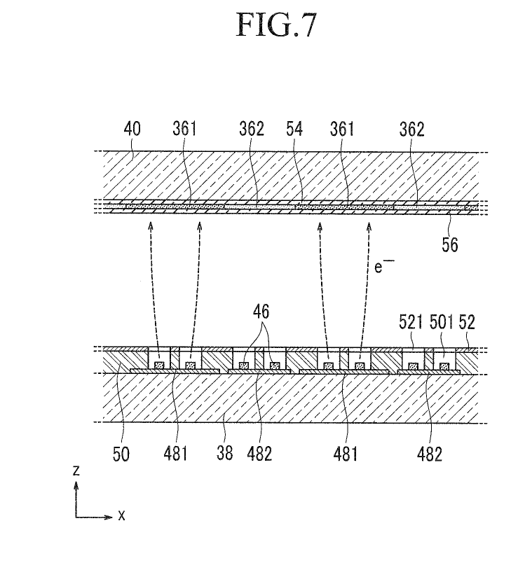

FIG. 5 is a partial exploded perspective view of the backlight panel illustrated in FIG. 1, and FIG. 6 is a partial cross-sectional view of the backlight panel illustrated in FIG. 1.

Referring to FIG. 5 and FIG. 6, the backlight panel 300 includes a first substrate 38 and a second substrate 40, which face each other. A sealing member (not shown) is located at an edge of the first substrate 38 and the second substrate 40 to join these substrates 38 and 40 to each other, and air in a space between the first substrate 38 and the second substrate 40 is exhausted to create a vacuum to the degree of about 10⁻⁶ Torr. Thus, a vacuum panel is constituted by the first substrate 38, the second substrate 40, and the sealing member.

An electron emission unit 42 is located at an inner surface of the first substrate 38 to emit electrons, and a light emission unit 44 is located at an inner surface of the second substrate 40 to emit visible light. The second substrate 40 having the light emission unit 44 may be a front substrate of the backlight panel 300.

The electron emission unit 42 includes an electron emission region 46 and driving electrodes for controlling electrons emitted from the electron emission region 46. The driving electrodes include cathode electrodes 48 formed in a stripe pattern extending in one direction (y-axis direction in the drawing) of the first substrate 38, gate electrodes 52 formed in a stripe pattern extending in a direction (x-axis direction in the drawing) that crosses the cathode electrodes 48 and are above the cathode electrodes 48, and an insulation layer 50 formed between the cathodes electrodes 48 and the gate electrodes 52.

Openings 521 and 501 are formed in the gate electrodes 52 and the insulation layer 50, respectively, in each crossing region of the cathode electrodes 48 and the gate electrodes 52 to expose a portion of the surface of the cathode electrodes 48. The electron emission region 46 is located on the cathode electrodes 48 exposed by the opening 501 of the insulation layer 50. One of the crossing regions of the cathode electrodes 48 and the gate electrodes 52 may correspond to one pixel area of the backlight panel 300.

The electron emission region 46 includes cold cathode electron emission materials for emitting electrons when electric field is applied in the vacuum state, for example carbon-based materials or nanometer-size materials. The electron emission region 46 can include, for example, carbon nanotubes, graphite, graphite nanofiber, diamond-like carbon, fullerene, silicon nanowire, and a material selected from a group composed of a combination thereof.

The light emission unit 44 includes an anode electrode 54 formed at the inner surface of the second substrate 40, a phosphor layer 36 located on one surface of the anode electrode 54, and a metal reflective layer 56 that covers the phosphor layer 36.

A high voltage (anode voltage) of 5 kV or more is applied to the anode electrode 54 to keep the phosphor layer 36 in a high potential state. Moreover, the anode electrode 54 is formed of a transparent conductive material such as indium tin oxide (ITO) to transmit the visible light emitted from the phosphor layer 36.

The phosphor layer 36 is made up of the first phosphor layer 361 including the red phosphor and the blue phosphor, and the second phosphor layer 362 including the green phosphor. The first phosphor layer 361 and the second phosphor layer 362 extend in parallel with each other along a width direction (y-axis direction in the drawing) of the gate electrode 52 in one pixel area. FIG. 5 and FIG. 6 illustrate an embodiment where two first phosphor layers 361 and two second phosphor layers 362 are alternately located along the length direction of the gate electrode 52 in one pixel area.

The metal reflective layer 56 may be an aluminum thin film having a thickness in thousands of angstroms (A), with fine holes formed therein to allow electron beams to pass through. The metal reflective layer 56 causes the visible light emitted toward the first substrate 38 from the phosphor layer 36 to be reflected back to the second substrate 40 to increase luminance of the backlight panel 300. In some embodiments, the anode electrode 54 may be omitted, in which case, the metal reflective layer 56 can function as an anode electrode by receiving the anode voltage.

According to the above described exemplary embodiment, the cathode electrode 48 is made up of a first sub-electrode 481 corresponding to the first phosphor layer 361 and a second sub-electrode 482 corresponding to the second phosphor layer 362. FIG. 5 and FIG. 6 illustrate an embodiment where one cathode electrode 48 is made up of two first sub-electrodes 481 and two second sub-electrodes 482 corresponding to the configuration of the above-described first phosphor layer 361 and second phosphor layer 362.

The first sub-electrodes 481 are electrically connected to each other in one cathode electrode 48 to receive the same driving voltage, and the second sub-electrodes 482 are also electrically connected to each other in one cathode electrode 48 to receive the same driving voltage.

The above-described backlight panel 300 applies a scan driving voltage to the gate electrodes 52, a data driving voltage to the cathode electrodes 48, and a 5 kV or more anode voltage to the anode electrode 54, for driving the gate electrodes 52, the cathode electrodes 48, and the anode electrode 54.

An on-time period of one pixel is divided into a first period and a second period. The data driving voltage is applied to the first sub-electrodes 481 during the first period, and the data driving voltage is then applied to the second sub-electrodes 482 during the second period.

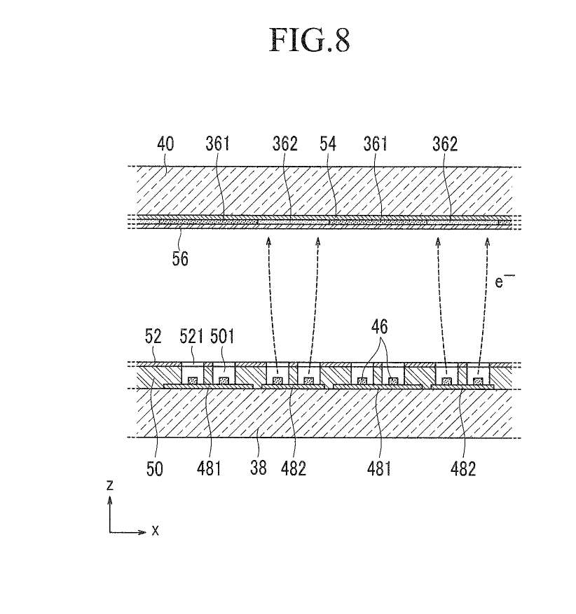

For pixels in which a voltage difference between the cathode electrode 48 and the gate electrode 52 is not less than a threshold value, the electric field is formed in the vicinity of the electron emission region 46 located at the first sub-electrodes 481 during the first period, and electrons are emitted by the electric field (see FIG. 7). The emitted electrons are guided by the anode voltage to collide with the corresponding first phosphor layer 361. As a result, light is emitted from the first phosphor layer 361.

Then, the electric field is formed in the vicinity of the electron emission region 46 located at the second sub-electrodes 482 during the second period, and electrons are emitted by the electric field (see FIG. 8). The emitted electrons collide with the second phosphor layer 362. As a result, light is emitted from the second phosphor layer 362.

As described above, since the cathode electrode 48 is divided into the first sub-electrodes 481 and the second sub-electrodes 482, light can be sequentially emitted from the first phosphor layer 361 and the second phosphor layer 362.

Referring back to FIG. 1, for the convenience of description, the pixel of the liquid crystal panel 200 is called the first pixel, the pixel of the backlight panel 300 is called the second pixel, and the first pixels corresponding to one second pixel are called a group of the first pixels.

A process for driving the backlight panel 300 may include 1) detecting the highest gray level among the gray levels of the first pixels that make up the group of the first pixels from the signal controller for controlling the liquid crystal panel 200, 2) calculating the gray level required for the second pixel emission according to the detected gray level and converting the calculated gray level to digital data, 3) generating a driving signal of the backlight panel 300 by using the digital data, and 4) applying the generated driving signal to driving electrodes of the backlight panel 300.

The driving signal of the backlight panel 300 is made up of the above-described scan driving signal and data driving signal. A scan printed circuit board assembly and a data printed circuit board assembly can be located at the rear of the backlight panel 300 to drive the backlight panel 300. In FIG. 1, a first connector 58 is provided for connecting the cathode electrodes 48 to the data printed circuit board assembly, and a second connector 60 is provided for connecting the gate electrodes 52 to the scan printed circuit board assembly. In addition, a third connector 62 is provided for applying the anode voltage to the anode electrodes 54.

The LCD according to the described embodiments of the present invention changes the structure of the color filter of the liquid crystal panel and the phosphor layer of the backlight panel and increases the transmittance of the blue light and the red light in the white light emitted from the backlight panel, thereby improving the efficiency of the blue phosphor and the red phosphor. Accordingly, the LCD according to the described embodiments of the present invention can easily realize the color temperature required for the liquid crystal panel.

While this invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims and equivalents thereof.

What is claimed is:

1. A liquid crystal display comprising:
a liquid crystal panel having a color filter comprising a red filter, a transparent filter, and a blue filter; and
a backlight panel at a rear of the liquid crystal panel, the backlight panel comprising electron emission regions and a phosphor layer configured to emit light when excited by electrons emitted from the electron emission regions,
wherein the phosphor layer comprises:
a first phosphor layer comprising a red phosphor and a blue phosphor; and
a second phosphor layer comprising a green phosphor,
wherein the backlight panel is configured to emit light from the first phosphor layer and the second phosphor layer sequentially.

2. The liquid crystal display of claim 1, wherein the backlight panel comprises a plurality of pixels, and at least one of the first phosphor layer and the second phosphor layer correspond to each of the pixels included in the backlight panel.

3. The liquid crystal display of claim 2, wherein the number of pixels in the backlight panel is less than that in the liquid crystal panel.

4. The liquid crystal display of claim 1, wherein the backlight panel comprises:
a first substrate on which the plurality of electron emission regions are located;
cathode electrodes and gate electrodes on a surface of the first substrate with an insulation layer therebetween, the cathode electrodes crossing the gate electrodes at a substantially right angle;
a second substrate facing the first substrate, wherein the phosphor layer is located on the second substrate; and
an anode electrode on a surface of the second substrate.

5. The liquid crystal display of claim 4, wherein
a crossing region of the cathode electrodes and the gate electrodes corresponds to one pixel among a plurality of pixels included in the backlight panel, and at least one of the first phosphor layer and the second phosphor layer correspond to each of the pixels of the backlight panel.

6. The liquid crystal display of claim 5, wherein the first phosphor layer and the second phosphor layer extend in parallel with each other along a width direction of the gate electrodes.

7. The liquid crystal display of claim 6, wherein each of the cathode electrodes comprises a first sub-electrode corresponding to the first phosphor layer and a second sub-electrode corresponding to the second phosphor layer, and the first sub-electrode and the second sub-electrode are separated from each other.

8. The liquid crystal display of claim 7, wherein an on-time period of each of the plurality of pixels in the backlight panel is divided into a first period and a second period.

9. The liquid crystal display of claim 8, wherein the backlight panel is configured to emit light from the first phosphor layer during the first period, and to emit light from the second phosphor layer during the second period.

10. The liquid crystal display of claim 8, wherein the backlight panel is configured to apply a driving voltage to the first sub-electrode during the first period, and apply a driving voltage to the second sub-electrode during the second period.

11. The liquid crystal display of claim 4, wherein the liquid crystal panel comprises first pixels, the backlight panel comprises a number of second pixels that is less than that of the first pixels, and the second pixels are configured to independently emit light in response to gray levels of the first pixels corresponding thereto.
